(19) United States
(12) Patent Application Publication
(10) Pub. No.: US 2020/0328476 A1
(43) Pub. Date: Oct. 15, 2020

(54) SECONDARY BATTERY

(71) Applicant: HONDA MOTOR CO., LTD., Tokyo (JP)

(72) Inventors: Masahiro Ohta, Wako-shi (JP); Wataru Shimizu, Wako-shi (JP); Toru Sukigara, Wako-shi (JP)

(21) Appl. No.: 16/840,480

(22) Filed: Apr. 6, 2020

(30) Foreign Application Priority Data
Apr. 12, 2019 (JP) 2019-076391

(51) Int. Cl. H01M 10/0587; H01M 10/0585

(52) U.S. Cl. CPC H01M 10/0587; H01M 10/0585

(57) ABSTRACT

A secondary battery 100 of the present invention includes a laminate 104 formed by alternately laminating a positive electrode 102 and a negative electrode 103 with an electrolyte 101 disposed therebetween; a first rod-shaped member 106 and a second rod-shaped member 107 which each extends in one direction D; and a first plate-shaped member 108 and a second plate-shaped member 109 which fix a positional relationship between the first rod-shaped member 106 and the second rod-shaped member 107, in which the laminate 104 is wound around the first rod-shaped member 106, the second rod-shaped member 107, and a space interposed therebetween, and the laminate 104 is compressed toward a space 110.

### BACKGROUND OF THE INVENTION

### Field of the Invention

The present invention relates to a secondary battery.

Priority is claimed on Japanese Patent Application No. 2019-076391, filed Apr. 12, 2019, the content of which is incorporated herein by reference.

### Description of Related Art

Secondary batteries such as lithium ion batteries can be repeatedly charged and discharged and have a high energy density, and thus are applied in various technical fields such as small portable devices and electric vehicles. Some secondary batteries exchange ions between a positive electrode and a negative electrode via an electrolyte. However, since an electrolyte of secondary batteries that have been widely used is a liquid, measures are required to prevent liquid leakage, which leads to a problem of a narrow degree of freedom in design. In view of this problem, all-solid-state batteries having an electrolyte formed of a solid material have attracted attention in recent years.

As disclosed in Patent Document 1, all-solid-state batteries are obtained by coating both surfaces of a current-collecting foil with an electrode composite material, producing a sheet by disposing a solid electrolyte on the upper surface for each of a positive electrode and a negative electrode, cutting each sheet into a suitable shape, and alternately laminating and press-forming them.

### PATENT DOCUMENTS

[Patent Document 1] Japanese Unexamined Patent Application, First Publication No. 2015-118870

### SUMMARY OF THE INVENTION

All-solid-state batteries have the following problems. Because all-solid-state batteries have insufficient strength, they may reach a state in which torsion and bending occur in a laminate structure thereof due to high contact pressure applied during press forming, which causes not only variations in initial performance but also causes a reduction in lifespan. In addition, in a case where a reinforcing member is added to an all-solid-state battery that has been subjected to press forming, there is a problem of a reduction in energy density and output density occurring in the all-solid-state battery due to an increase in volume and weight.

The present invention has been made in view of the above circumstances, and an object thereof is to provide a secondary battery in which the occurrence of torsion and bending in a laminate structure is curbed.

In order to solve the above-described problems, the present invention employs the following means.

(1) A secondary battery according to one aspect of the present invention includes a laminate formed by alternately laminating a positive electrode and a negative electrode with an electrolyte disposed therebetween; a first rod-shaped member and a second rod-shaped member which each extends in one direction; and a first plate-shaped member and a second plate-shaped member which fix a positional relationship between the first rod-shaped member and the second rod-shaped member, in which the laminate is wound around the first rod-shaped member, the second rod-shaped member, and a space interposed therebetween, and the laminate is compressed toward the space.

(2) A secondary battery according to another aspect of the present invention includes a laminate formed by alternately laminating a positive electrode and a negative electrode with an electrolyte disposed therebetween; a first rod-shaped member and a second rod-shaped member which each extends in one direction and has a gripping part for gripping the laminate; and a first plate-shaped member and a second plate-shaped member which fix a positional relationship between the first rod-shaped member and the second rod-shaped member, in which the laminate is disposed in a space interposed between the first rod-shaped member and the second rod-shaped member, an end part of the laminate is gripped by the gripping part, and the laminate is compressed in a thickness direction.

(3) In the secondary battery according to (1) or (2), one end of each of the first rod-shaped member and the second rod-shaped member preferably penetrates through the first plate-shaped member in a thickness direction, and the other end of each of the first rod-shaped member and the second rod-shaped member preferably penetrates through the second plate-shaped member in the thickness direction.

(4) In the secondary battery according to any one of (1) to (3), the first rod-shaped member and the second rod-shaped member preferably have conductivity, and are preferably respectively electrically connected to one of the first plate-shaped member and the second plate-shaped member and electrically insulated from the other one thereof.

(5) In the secondary battery according to (4), the first plate-shaped member and the second plate-shaped member may be insulators, and in a region interposed between the first plate-shaped member and the second plate-shaped member, one of the first rod-shaped member and the second rod-shaped member may be electrically connected to a positive electrode current collector, and the other thereof may be electrically connected to a negative electrode current collector.

(6) In the secondary battery according to any one of (1) to (5), the first rod-shaped member and the second rod-shaped member are preferably rounded in a circumferential direction.

In a secondary battery of the present invention, two rod-shaped members of which a positional relationship is fixed support a laminate formed by alternately laminating a positive electrode and a negative electrode with an electrolyte disposed therebetween. These members function as a basic skeleton, and thereby shape stability of the laminate can be reinforced. Accordingly, the occurrence of torsion and bending in a laminate structure can be curbed in the secondary battery of the present invention even in a case where high contact pressure is applied during press forming.

### BRIEF DESCRIPTION OF THE DRAWINGS

FIG. 1A is a perspective view of a secondary battery according to a first embodiment of the present invention.

FIG. 1B is a cross-sectional view of the secondary battery according to the first embodiment of the present invention.

FIG. 2 is a perspective view of a reinforcing unit constituting the secondary battery of FIG. 1.

FIG. 3 is a development view of a positive electrode and a negative electrode constituting the secondary battery of FIG. 1.

FIG. 4A is a perspective view of a secondary battery according to a second embodiment of the present invention.

FIG. 4B is a cross-sectional view of the secondary battery according to the second embodiment of the present invention.

FIG. 5 is a perspective view of a reinforcing unit constituting the secondary battery of FIGS. 4A and 4B.

### DETAILED DESCRIPTION OF THE INVENTION

Hereinafter, a secondary battery according to an embodiment to which the present invention is applied will be described in detail with reference to the drawings. In the drawings used in the following description, characteristic portions may be enlarged for convenience to facilitate understanding of the characteristics, and the dimensional ratios and the like of the respective components are not necessarily the same as the actual ones. In addition, materials, dimensions, and the like exemplified in the following description are merely examples, and the present invention is not limited thereto and can be implemented with appropriate changes without departing from the scope of the invention.

### First Embodiment

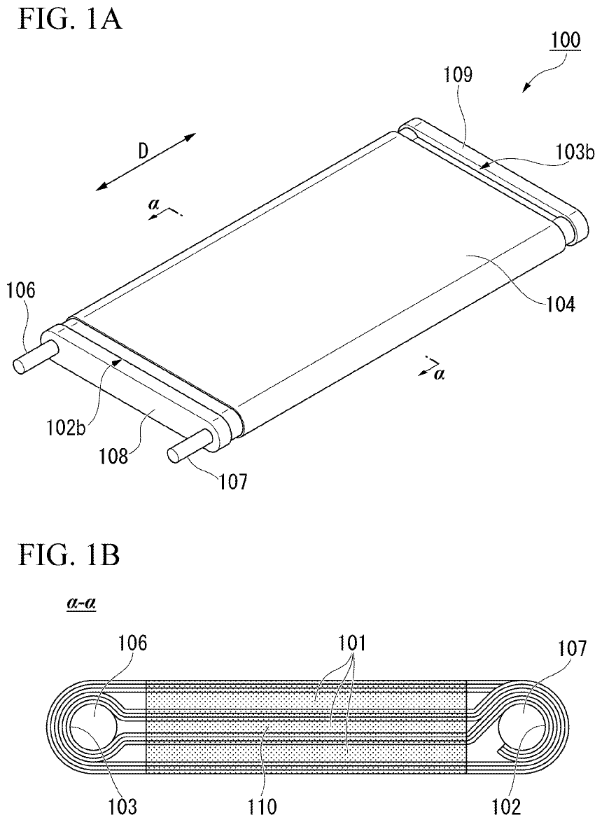

FIG. 1A is a perspective view of a secondary battery 100 according to a first embodiment of the present invention. FIG. 1B is a cross-sectional view of the secondary battery 100 of FIG. 1A which is cut at a position indicated by an α-α line. The secondary battery 100 is a wound-type secondary battery, and mainly includes a laminate 104 formed by alternately laminating a positive electrode 102 and a negative electrode 103 with an electrolyte 101 disposed therebetween, and a reinforcing unit 105 for reinforcing the laminate 104.

[Reinforcing Unit]

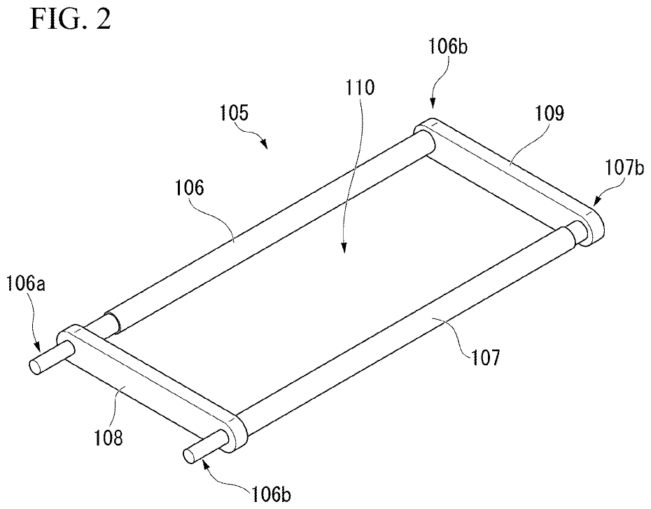

FIG. 2 is a perspective view of the reinforcing unit 105. The reinforcing unit 105 is mainly configured of two rod-shaped members (a first rod-shaped member 106 and a second rod-shaped member 107), and two plate-shaped members (a first plate-shaped member 108 and a second plate-shaped member 109). The first rod-shaped member 106 and the second rod-shaped member 107 are disposed to extend in one common direction D (disposed substantially parallel to each other).

One end side 106a and one end side 107a of the respective first rod-shaped member 106 and the second rod-shaped member 107 penetrate through the first plate-shaped member 108 in a thickness direction. In addition, the other end side 106b and the other end side 107b of the respective first rod-shaped member 106 and the second rod-shaped member 107 penetrate through the second plate-shaped member 109 in the thickness direction. A positional relationship (relative distance, relative angle, and the like) between the first rod-shaped member 106 and the second rod-shaped member 107 is fixed by the first plate-shaped member 108 and the second plate-shaped member 109.

The present embodiment exemplifies a case in which the laminate 104 is wound around the first rod-shaped member 106, the second rod-shaped member 107, and a space 110 interposed therebetween. More specifically, the laminate 104 is deformed such that the positive electrode 102 is in contact with the second rod-shaped member 107 and the negative electrode 103 is in contact with the first rod-shaped member 106. Accordingly, in a cross-sectional view in the extending direction of the first rod-shaped member 106 and the second rod-shaped member 107, the laminate 104 has an S shape as shown in FIG. 1B.

Both the first rod-shaped member 106 and the second rod-shaped member 107 have conductivity and thus can function as part of a current collector of the secondary battery 100. As a material of the first rod-shaped member 106 and the second rod-shaped member 107, for example, aluminum, stainless steel, nickel, iron, copper, silver, palladium, gold, platinum, and the like can be used. In addition, the first rod-shaped member 106 and the second rod-shaped member 107 are each electrically connected to one of the first plate-shaped member 108 and the second plate-shaped member 109, and are each electrically insulated from the other thereof. Portions of the first rod-shaped member 106 and the second rod-shaped member 107 which are not electrically connected are coated with an insulation material. As a material of the first plate-shaped member 108 and the second plate-shaped member 109, for example, a metal such as aluminum, stainless steel, nickel, iron, copper, silver, palladium, gold, and platinum, or known insulating materials can be used. In a case where the first plate-shaped member 108 and the second plate-shaped member 109 are insulators, in a region interposed between the first plate-shaped member 108 and the second plate-shaped member 109, it is sufficient for one of the first rod-shaped member 106 and the second rod-shaped member 107 to be electrically connected to a positive electrode current collector, and the other thereof to be electrically connected to a negative electrode current collector. For example, portions which are not coated with an insulation material may be provided at the one end side 106a of the first rod-shaped member, the other end side 107b of the second rod-shaped member, and the like, and may be electrically connected to a positive electrode current collector or a negative electrode current collector by a welding method or the like.

More specifically, the one end side 106a or the other end side 106b of the first rod-shaped member is welded to any one of the first plate-shaped member 108 or the second plate-shaped member 109, and similarly, the one end side 107a or the other end side 107b of the second rod-shaped member is welded to any one of the first plate-shaped member 108 or the second plate-shaped member 109. In addition, an end part side, which is not welded, of the respective first rod-shaped member 106 and the second rod-shaped member 107 is covered with, for example, an insulating film such as SiO₂ so as not to be short-circuited with a counter electrode.

It is preferable that the first rod-shaped member 106 and the second rod-shaped member 107, particularly outer sides thereof (a side opposite to the space 110), be rounded in a circumferential direction. In a case where the first rod-shaped member 106 and the second rod-shaped member 107 are rounded in the circumferential direction, the laminate can be pressed against them, and thereby damage to the laminate can be reduced.

[Laminate]

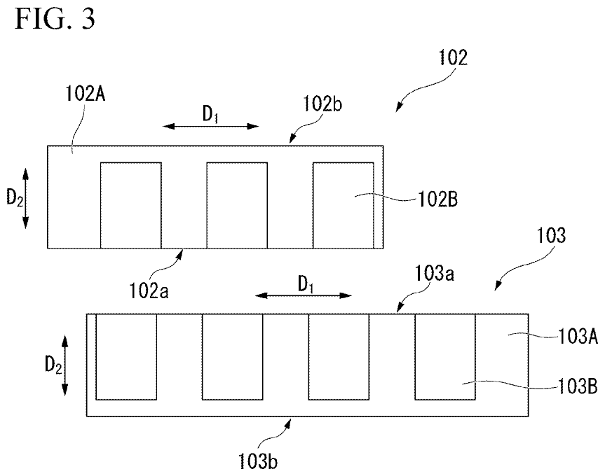

FIG. 3 is a development view of a positive electrode sheet (a positive electrode) 102 and a negative electrode sheet (a negative electrode) 103 which constitute the laminate 104.

As shown in FIG. 3, in the positive electrode sheet 102, a plurality of islands formed of a plurality of pieces of positive electrode composite material 102B are formed side by side at predetermined intervals on a current collector 102A made of a conductive material such as aluminum in a longitudinal direction (a winding direction) D₁. The islands of the positive electrode composite material 102B are formed on the positive electrode sheet 102 from one end 102a to just before the other end 102b in a width direction D₂. The other end 102b side on which the positive electrode composite material 102B is not formed becomes a joint part with the first plate-shaped member 108 or the second plate-shaped member 109 when a laminate is wound.

The positive electrode composite material mainly contains a positive electrode active material, and may further contain an electrolyte, a binder, and a conductive auxiliary agent as needed. As the positive electrode active material, it is possible to use known materials, for example, composite oxides containing lithium and a transition metal such as lithium cobaltate (LiCoO₂), lithium nickelate (LiNiO₂), lithium manganate (LiMnO₂), lithium manganese spinel (LiMn₂O₄), and olivine type lithium phosphate (LiFePO₄); conductive polymers such as polyaniline and polypyrrole; sulfides such as Li₂S, CuS, and Li—Cu—S compounds, and TiS₂, FeS, MoS₂, and Li—Mo—S compounds; a mixture of sulfur and carbon; and the like. As the positive electrode active material, one of the above materials may be used alone, or two or more kinds thereof may be used in combination.

As shown in FIG. 3, in the negative electrode sheet 103, a plurality of islands formed of a plurality of pieces of negative electrode composite material 103B are formed side by side at predetermined intervals on a current collector 103A made of a conductive material such as aluminum in the longitudinal direction D₁. The islands of the negative electrode composite material 103B are formed on the negative electrode sheet 103 from one end 103a to just before the other end 103b in the width direction D₂. The other end 103b side on which the negative electrode composite material 103B is not formed becomes a joint part with the first plate-shaped member 108 or the second plate-shaped member 109 when a laminate is wound.

The negative electrode composite material mainly contains a negative active material, and may further contain an electrolyte, a binder, and a conductive auxiliary agent as needed. As the negative electrode active material, it is possible to use known materials, for example, metal elements such as indium, aluminum, silicon, tin, and lithium, and alloys thereof; inorganic oxides (for example Li₄Ti₅O₁₂) and the like; carbon active materials (for example, mesocarbon microbeads (MCMB), highly oriented graphite (HOPG), hard carbon, soft carbon, and the like); conductive polymers such as polyacene, polyacetylene, and polypyrrole; and the like. As the negative electrode active material, one of the above materials may be used alone, or two or more kinds thereof may be used in combination.

As the binder contained in the positive electrode composite material and the negative electrode composite material, it is possible to use fluororesins such as polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF); acrylic acid-based polymers; cellulose-based polymers; styrene-based polymers; styrene-butadiene copolymers; vinyl acetate-based polymers; urethane-based polymers; and the like. As the binder, one of the above materials may be used alone, or two or more kinds thereof may be used in combination.

As the conductive auxiliary agent contained in the positive electrode composite material and the negative electrode composite material, it is possible to use carbon powders such as carbon black, carbon nanotubes, carbon materials, fine powders of metal such as copper, nickel, stainless steel, and iron, a mixture of carbon materials and metal fine powders, and conductive oxides such as ITO. As the conductive auxiliary agent, one of the above materials may be used alone, or two or more kinds thereof may be used in combination.

It is sufficient for a material of an electrolyte 201 to have low electron conductivity and high lithium ionic conductivity. The electrolyte 201 of the present embodiment may be solid or may be liquid.

As the solid electrolyte, for example, it is possible to use at least one kind selected from the group consisting of perovskite compounds such as La_{0.5}Li_{0.34}TiO_{2.94} and La_{0.5}Li_{0.5}TiO₃, lisicon-type compounds such as Li₁₄Zn(GeO₄)₄, garnet-type compounds such as Li₇La₃Zr₂O₁₂, nasicon-type compounds such as Li_{1.3}Al_{0.3}Ti_{1.7}(PO₄)₃ and Li_{1.5}Al_{0.5}Ge_{1.5} (PO₄)₃, thio-lisicon-type compounds such as Li_{3.25}Ge_{0.25}P_{0.75}S₄ and Li₃PS₄, glass compounds such as 50Li₄SiO_{4.50}Li₃BO₃, Li₂S—P₂S₅, and Li₂O—Li₃O₅—SiO₂, phosphoric acid compounds such as Li₃PO₄, Li_{3.5}Si_{0.5}P_{0.5}O₄, and Li_{2.9}PO_{3.3}N_{0.46}, and amorphous ones such as Li_{2.9}PO_{3.3}N_{0.46} (LIPON) and Li_{3.6}Si_{0.6}P_{0.4}O₄, glass ceramics such as Li_{1.07}Al_{0.69}Ti_{1.46}(PO₄)₃ and Li_{1.5}Al_{0.5}Ge_{1.5}(PO₄)₃, inorganic solid electrolytes such as lithium-containing salts, polymer-based solid electrolytes such as polyethylene oxide, gel-based solid electrolytes containing a lithium-containing salt or a lithium-ion conductive ionic liquid, and the like. A solid electrolyte used for the electrolyte 201 may be the same as or different from the solid electrolyte contained in the positive electrode composite material and the solid electrolyte contained in the negative electrode composite material.

As a liquid electrolyte (a non-aqueous electrolyte), for example, it is possible to use salts containing a cation and an anion in which the cation is lithium or a quaternary ammonium cation such as tetraethylammonium, triethylmethylammonium, spiro-(1,1′)-bipyrrolidinium, or diethylmethyl-2-methoxyethylammonium (DEME), or is an imidazolium cation such as 1,3-dialkylimidazolium, 1,2,3-trialkylimidazolium, 1-ethyl-3-methylimidazolium (EMI), or 1,2-dimethyl-3-propylimidazolium (DMPI), and the anion is BF₄⁻, PF₆⁻, ClO₄⁻, AlCl₄⁻, or CF₃SO₃⁻; and ionic liquids such as LiTFSi.

Examples of these solvents include organic solvents such propylene carbonate (PC), ethylene carbonate (EC), dimethyl carbonate (DMC), diethyl carbonate (DEC), acetonitrile (AN), propionitrile, γ-butyrolactone (BL), dimethylformamide (DMF), tetrahydrofuran (THF), dimethoxyethane (DME), dimethoxymethane (DMM), sulfolane (SL), dimethylsulfoxide (DMSO), ethylene glycol, propylene glycol, and methylcellosolve; and the like. These may be used alone, or two or more kinds thereof may be mixed at any ratio and used.

As described above, in the secondary battery 100 according to the present embodiment, the two rod-shaped members 106 and 107 of which a positional relationship is fixed support the laminate 104 formed by alternately laminating a positive electrode and a negative electrode with an electrolyte disposed therebetween. These members function as a basic skeleton, and thereby shape stability of the laminate 104 can be reinforced. Accordingly, the occurrence of torsion and bending in a laminate structure can be curbed in the secondary battery 100 according to the present embodiment even in a case where high contact pressure is applied during press forming.

### Second Embodiment

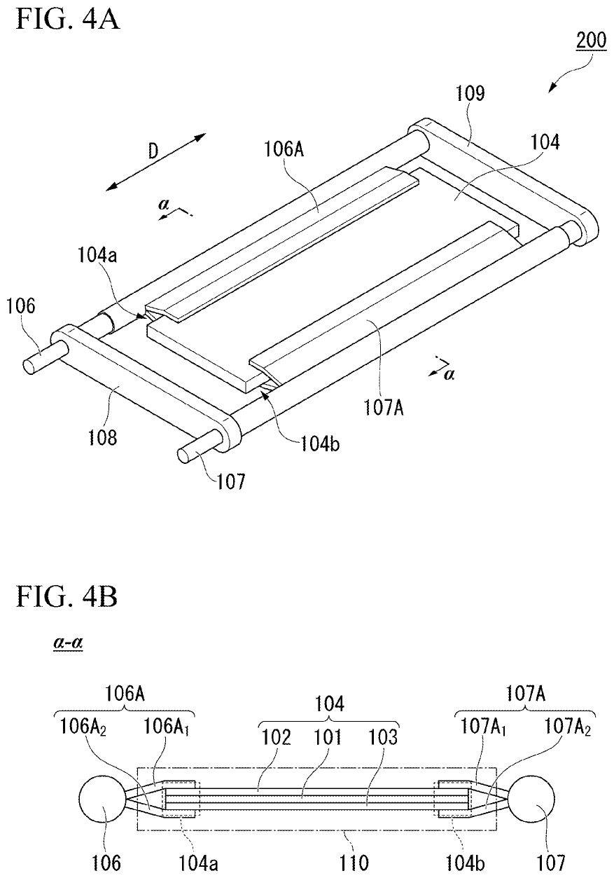

FIG. 4A is a perspective view of a secondary battery 200 according to a second embodiment of the present invention. FIG. 4B is a cross-sectional view of the secondary battery 200 of FIG. 4A which is cut at a position indicated by an α-α line. The secondary battery 200 is a laminate-type secondary battery, and includes a reinforcing unit 105 that reinforces a laminate 104 similarly to the secondary battery 100 of the first embodiment. However, in the present embodiment, a first rod-shaped member 106 and a second rod-shaped member 107 which constitute the reinforcing unit 105 include gripping parts 106A and 107A that respectively grip the laminate. A configuration of the other parts is the same as the configuration of the reinforcing unit 105 of the first embodiment, and the corresponding portions are denoted by the same reference numerals regardless of differences in shape.

The laminate 104 is disposed in a space 110 interposed between the first rod-shaped member 106 and the second rod-shaped member 107 such that its longitudinal direction is substantially parallel to an extending direction of the first rod-shaped member 106 and the second rod-shaped member 107. In addition, in the laminate 104, an end part 104a on the first rod-shaped member 106 side is gripped by the gripping part 106A, and an end part 104b on the second rod-shaped member 107 side is gripped by the gripping part 107A.

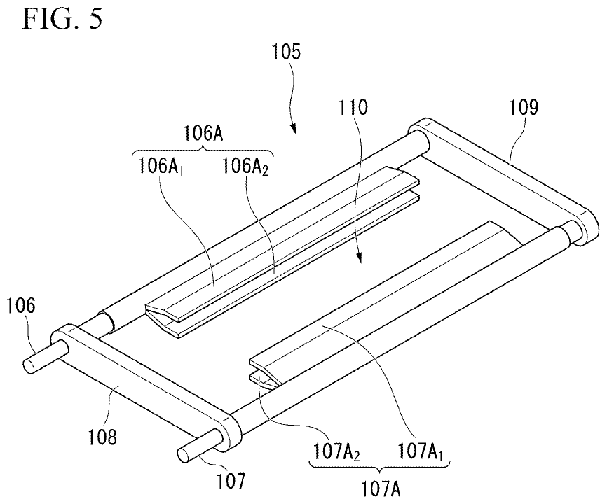

In FIG. 5, the gripping part 106A has a pair of third plate-shaped members 106A₁ and 106A₂ which are connected to each other in an interlocking manner via the first rod-shaped member 106, and is configured such that a distance between the third plate-shaped members is freely changeable. In addition, the gripping part 107A has a pair of third plate-shaped members 107A₁ and 107A₂ which are connected to each other in an interlocking manner via the first rod-shaped member 107, and is configured such that a distance between the third plate-shaped members is freely changeable. The laminate 104 can be gripped by respectively shortening a distance between the third plate-shaped member 106A₁ and the third plate-shaped member 106A₂ and a distance between the third plate-shaped member 107A₁ and the third plate-shaped member 107A₂. Conversely, the laminate 104 can be opened by extending each of the distances.

At least one of the third plate-shaped members 106A₁ and 107A₁ which come in contact with a positive electrode 102 is a conductive member, and the positive electrode 102 is electrically connected to a first plate-shaped member 108 or a second plate-shaped member 109 via the first rod-shaped member 106 or the second rod-shaped member 107. In addition, at least one of the third plate-shaped members 106A₂ and 107A₂ which come in contact with a negative electrode 103 is a conductive member, and the negative electrode 102 is electrically connected to a first plate-shaped member 108 or a second plate-shaped member 109 via the first rod-shaped member 106 or the second rod-shaped member 107.

The shape of the third plate-shaped members 106A₁, 106A₂, 107A₁, and 107A₂ is not particularly limited, but the shape is preferably bent in a manner following the shape of the laminate 104 in the vicinity of the laminate 104 to be gripped so that a contact area with the laminate 104 is increased. By increasing the contact area with the laminate 104, the gripping force can be increased, and excessive local pressure can be prevented from being applied to the laminate 104.

As described above, also in the secondary battery 200 according to the present embodiment, the two rod-shaped members 106 and 107 of which a positional relationship is fixed support the laminate 104 formed by alternately laminating a positive electrode and a negative electrode with an electrolyte disposed therebetween. These members function as a basic skeleton, and thereby shape stability of the laminate 104 can be reinforced. Accordingly, the occurrence of torsion and bending in a laminate structure can be curbed in the secondary battery 200 according to the present embodiment even in a case where high contact pressure is applied during press forming.

### EXPLANATION OF REFERENCES

100, 200 Secondary battery
101 Electrolyte
102 Positive electrode
102A Current collector
102B Positive electrode composite material
103 Negative electrode
103A Current collector
103B Negative electrode composite material
104 Laminate
104a One end of laminate
104b Other end of laminate
105 Reinforcing unit
106 First rod-shaped member
106a One end of first rod-shaped member
106b Other end of first rod-shaped member
106A Gripping part
106A₁, 106A₂ Third plate-shaped member
107 Second rod-shaped member
107a One end of second rod-shaped member
107b Other end of second rod-shaped member
107A Gripping part
107A₁, 107A₂ Third plate-shaped member
108 First plate-shaped member
109 Second plate-shaped member
110 Space

What is claimed is:

1. A secondary battery, comprising:
a laminate formed by alternately laminating a positive electrode and a negative electrode with an electrolyte disposed therebetween;
a first rod-shaped member and a second rod-shaped member which each extends in one direction; and
a first plate-shaped member and a second plate-shaped member which fix a positional relationship between the first rod-shaped member and the second rod-shaped member,
wherein the laminate is wound around the first rod-shaped member, the second rod-shaped member, and a space interposed therebetween, and
the laminate is compressed toward the space.

2. A secondary battery, comprising:
a laminate formed by alternately laminating a positive electrode and a negative electrode with an electrolyte disposed therebetween;
a first rod-shaped member and a second rod-shaped member which each extends in one direction and includes a gripping part for gripping the laminate; and
a first plate-shaped member and a second plate-shaped member which fix a positional relationship between the first rod-shaped member and the second rod-shaped member,
wherein the laminate is disposed in a space interposed between the first rod-shaped member and the second rod-shaped member,
an end part of the laminate is gripped by the gripping part, and
the laminate is compressed in a thickness direction.

3. The secondary battery according to claim 1,
wherein one end of each of the first rod-shaped member and the second rod-shaped member penetrates through the first plate-shaped member in a thickness direction, and
the other end of each of the first rod-shaped member and the second rod-shaped member penetrates through the second plate-shaped member in the thickness direction.

4. The secondary battery according to claim 2,
wherein one end of each of the first rod-shaped member and the second rod-shaped member penetrates through the first plate-shaped member in a thickness direction, and
the other end of each of the first rod-shaped member and the second rod-shaped member penetrates through the second plate-shaped member in the thickness direction.

5. The secondary battery according to claim 1,
wherein the first rod-shaped member and the second rod-shaped member have conductivity, and are each electrically connected to one of the first plate-shaped member and the second plate-shaped member and electrically insulated from the other one thereof.

6. The secondary battery according to claim 2,
wherein the first rod-shaped member and the second rod-shaped member have conductivity, and are each electrically connected to one of the first plate-shaped member and the second plate-shaped member and electrically insulated from the other one thereof.

7. The secondary battery according to claim 3,
wherein the first rod-shaped member and the second rod-shaped member have conductivity, and are each electrically connected to one of the first plate-shaped member and the second plate-shaped member and electrically insulated from the other one thereof.

8. The secondary battery according to claim 4,
wherein the first rod-shaped member and the second rod-shaped member have conductivity, and are each electrically connected to one of the first plate-shaped member and the second plate-shaped member and electrically insulated from the other one thereof.

9. The secondary battery according to claim 5,
wherein the first plate-shaped member and the second plate-shaped member are insulators, and in a region interposed between the first plate-shaped member and the second plate-shaped member, one of the first rod-shaped member and the second rod-shaped member is electrically connected to a positive electrode current collector, and the other thereof is electrically connected to a negative electrode current collector.

10. The secondary battery according to claim 6,
wherein the first plate-shaped member and the second plate-shaped member are insulators, and in a region interposed between the first plate-shaped member and the second plate-shaped member, one of the first rod-shaped member and the second rod-shaped member is electrically connected to a positive electrode current collector, and the other thereof is electrically connected to a negative electrode current collector.

11. The secondary battery according to claim 7,
wherein the first plate-shaped member and the second plate-shaped member are insulators, and in a region interposed between the first plate-shaped member and the second plate-shaped member, one of the first rod-shaped member and the second rod-shaped member is electrically connected to a positive electrode current collector, and the other thereof is electrically connected to a negative electrode current collector.

12. The secondary battery according to claim 8,
wherein the first plate-shaped member and the second plate-shaped member are insulators, and in a region interposed between the first plate-shaped member and the second plate-shaped member, one of the first rod-shaped member and the second rod-shaped member is electrically connected to a positive electrode current collector, and the other thereof is electrically connected to a negative electrode current collector.

13. The secondary battery according to claim 1,
wherein the first rod-shaped member and the second rod-shaped member are rounded in a circumferential direction.

14. The secondary battery according to claim 2,
wherein the first rod-shaped member and the second rod-shaped member are rounded in a circumferential direction.

15. The secondary battery according to claim 3,
wherein the first rod-shaped member and the second rod-shaped member are rounded in a circumferential direction.

16. The secondary battery according to claim 4,
wherein the first rod-shaped member and the second rod-shaped member are rounded in a circumferential direction.

17. The secondary battery according to claim 5,
wherein the first rod-shaped member and the second rod-shaped member are rounded in a circumferential direction.

18. The secondary battery according to claim 6,
wherein the first rod-shaped member and the second rod-shaped member are rounded in a circumferential direction.

19. The secondary battery according to claim 7,
wherein the first rod-shaped member and the second rod-shaped member are rounded in a circumferential direction.

20. The secondary battery according to claim 8,
wherein the first rod-shaped member and the second rod-shaped member are rounded in a circumferential direction.
